(19) United States
(12) Patent Application Publication
(10) Pub. No.: US 2017/0261138 A1
(43) Pub. Date: Sep. 14, 2017

(54) FLUID CONNECTION PORTS

(71) Applicant: UNIVERSITY OF SOUTH AUSTRALIA, Adelaide (AU)

(72) Inventor: Luke PARKINSON, Kensington Park (AU)

(73) Assignee: UNIVERSITY OF SOUTH AUSTRALIA, Adelaide (AU)

(21) Appl. No.: 15/482,224

(22) Filed: Apr. 7, 2017

Related U.S. Application Data
(63) Continuation of application No. 14/411,002, filed on Dec. 23, 2014, now abandoned.

(30) Foreign Application Priority Data
Jun. 29, 2012 (AU) 2012902785

(51) Int. Cl. F16L 33/24; F16L 11/04; F16L 21/00; F16L 33/32; B01L 3/00; F16L 19/065

(52) U.S. Cl. CPC F16L 33/24; B01L 3/502715; B01L 2200/027; B01L 2200/0689; B01L 2300/0816; F16L 2201/44; F16L 11/04; F16L 19/0653; F16L 21/007; F16L 33/32

(57) ABSTRACT

Disclosed herein is a fluid connection port for forming a working fluid connection between a deformable, flexible tube and a fluid handling device, the fluid connection port comprising a bore extending from an exterior surface of the fluid handling device to an internal fluid handling feature, the bore comprising a narrow diameter bore section adjacent the exterior surface of the fluid handling device, a larger diameter bore section adjacent the internal fluid handling feature, and a shoulder separating the narrow diameter bore section and the larger diameter bore section, wherein the diameter of the bore at the narrow diameter bore section is less than the outside diameter of the deformable, flexible tube.

### PRIORITY DOCUMENTS

The present application claims priority from Australian Provisional Patent Application No. 2012902785 titled “FLUID CONNECTION PORT FOR MICROFLUIDIC DEVICES” and filed on 29 Jun. 2012, the contents of which are hereby incorporated by reference in their entirety.

### TECHNICAL FIELD

The present invention relates to fluid connection ports for connecting flexible tubing to devices such as microfluidic, medical or chromatography devices.

### BACKGROUND

Tubing connectors are used in a range of applications where there is a need to operatively connect flexible tubing to devices. For example, flexible capillary tubing is used to deliver fluids and gases under pressure in microfluidics, medical, laboratory and chromatography applications. In order to illustrate the present invention reference will now be made to the use of tubing in microfluidic devices but it will be appreciated that the invention may be utilised in a range of other applications as well.

Microfluidic devices are used to process small volumes of fluids in many application areas, such as biochemical assays, biochemical sensors, life science research, and chemical reactions. One type of microfluidic device is a microfluidic chip. Microfluidic chips typically include micro-scale features such as channels, valves, pumps, and/or reservoirs for storing fluids, for routing fluids to and from various locations on the chip, and/or for reacting fluidic reagents. A microfluidic chip that integrates various microfeatures to provide various fluid processing functions is sometimes referred to as a “lab-on-a-chip”.

The use of microfluidic chips requires a fluid to be introduced into the microfeatures from an external source. This is normally achieved by way of a fluid connection port in the form of a bore that passes from, and is open at, an outer surface of the chip through to a microchannel or other microfeature within the chip. The fluid connection port is connected to tubing which, in turn, is connected to a pump or supply of fluid to be introduced into the chip. Likewise, a microfluidic chip may also have a similarly configured outlet port through which fluid can exit the microchannel or other microfeature. A robust connection needs to be established between the external tubing and the microfluidic chip so that there is no fluid leakage and the connection also needs to withstand the relatively high pressures associated with pumping a fluid into the relatively small volume microchannel or other microfeature. Ideally, there will also be minimal dead-volume in the connection which may be filled with fluid.

Various arrangements have been used to connect tubing to a port in a microfluidic chip. An example of one arrangement is disclosed in United States Patent Application Publication No. US2002/0100714 A1 (Staats) which discloses a microfluidic device having access ports with capillaries attached with an adhesive. In practice, one of the more commonly used arrangements in lieu of a custom-built connector designed to attach to ports at standardised locations is a commercially available fitting available under the tradename NanoPort™ (eg Idex, Inc). The NanoPort™ connector comprises a base connector which is bonded to the external surface of the microfluidic chip and a tubing connector through which the tubing passes and which is threaded onto the base connector to form a fluid tight connection. The NanoPort™ connector is bonded to the external surface of the microfluidic chip using an epoxy-acrylic or epoxy-polyamide adhesive. Prior to bonding, the external surface of the microchip has to be cleaned and oxidised (eg. by plasma oxidation) to achieve sufficient bond strength. The adhesive also needs to be cured and this is achieved by heating the assembled microfluidic chip to a temperature and for a time that results in curing of the adhesive. For example, recommended curing times and temperatures are 2.5 hr at 100° C. for the acrylic-epoxy adhesive and 1.5 hr at 165° C. for the polyamide-epoxy resin. Such treatment is likely to degrade antibodies, proteins, functionalised surfaces and some other reagents likely to be present in many microfluidic devices. Whilst the fluid connection formed with the NanoPort™ connector is robust and reliable, it is fiddly, time consuming and expensive to fit to a microfluidic chip and is only really suited to one-off experimental-type work in a laboratory setting.

There is a need for fluid connection ports for microfluidic devices that are inexpensive and/or allow for relatively easy attachment of tubing to the device and provide for a robust connection that is able to withstand the typical working pressures and conditions of the device. Alternatively, or in addition, there is a need for alternatives to existing fluid connection ports for microfluidic devices.

### SUMMARY

In a first aspect, the present invention provides a fluid connection port for forming a working fluid connection between a deformable, flexible tube and a fluid handling device, the fluid connection port comprising a bore extending from an exterior surface of the fluid handling device to an internal fluid handling feature, the bore comprising a narrow diameter bore section adjacent the exterior surface of the device, a larger diameter bore section adjacent the internal fluid handling feature, and a shoulder separating the narrow diameter bore section and the larger diameter bore section, wherein the diameter of the bore at the narrow diameter bore section is less than the outside diameter of the deformable, flexible tube.

In embodiments, the fluid handling device is a microfluidic device. Thus, in a second aspect the present invention provides a microfluidic device comprising a substrate, at least one microfluidic channel or feature formed internally in the substrate and a fluid connection port for forming a working fluid connection between a deformable, flexible tube and the microfluidic device, the fluid connection port comprising a bore extending from an exterior surface of the microfluidic device to the microfluidic channel or feature, the bore comprising a narrow diameter bore section adjacent the exterior surface of the microfluidic device, a larger diameter bore section adjacent the internal microfluidic feature, and a shoulder separating the narrow diameter bore section and the larger diameter bore section, wherein the diameter of the bore at the narrow diameter bore section is less than the diameter of the deformable, flexible tube.

In embodiments, the diameter of the bore at the larger diameter bore section may also be marginally less than the outside diameter of the deformable, flexible tube.

In embodiments, an internal wall of the bore further comprises a threaded section. The threaded section assists in screwing the tube into the bore.

In embodiments, the threaded section comprises a single turn thread.

In embodiments, the threaded section comprises a single start thread. In other embodiments, the threaded section comprises a multiple start thread, for example a two start, three start or four start thread.

Advantageously, the tubing has a smooth outer surface and does not contain a threaded section and does not need to be modified or have anything added to it for it to be used in the fluid connection port of the present invention.

### BRIEF DESCRIPTION OF DRAWINGS

Illustrative embodiments of the present invention will be discussed with reference to the accompanying drawings wherein:

FIG. 1 shows a cross sectional view from the side of a substrate comprising a fluid connection port of embodiments of the invention;

FIG. 2 shows a cross sectional view from the side of a substrate comprising a fluid connection port of embodiments of the invention;

FIG. 3 shows a cross sectional line drawing of a microfluidic device comprising a fluid connection port of embodiments of the invention;

FIG. 4 shows a cross sectional line drawing of a substrate comprising a fluid connection port of embodiments of the invention;

FIG. 5 shows a cross sectional view from the side of a substrate comprising a fluid connection port of embodiments of the invention;

FIG. 6 shows a cross sectional view from the side of a substrate comprising a fluid connection port of embodiments of the invention;

FIG. 7 shows a cross sectional view from the side of a substrate comprising a fluid connection port of embodiments of the invention;

FIG. 8 shows a cross sectional view from the side of a substrate comprising a fluid connection port of embodiments of the invention;

FIG. 9 shows a cross sectional view from the side of a substrate comprising a fluid connection port of embodiments of the invention;

FIG. 10 shows a cross sectional line drawing from the side of a microfluidic device comprising a fluid connection port of embodiments of the invention with a tube connected thereto;

FIG. 11 shows a cross sectional line drawing from the side of a microfluidic device comprising a fluid connection port of embodiments of the invention with a tube connected thereto;

FIG. 12 shows a perspective line drawing of a fluid connection port of embodiments of the invention comprising a two start thread;

FIG. 13 shows a perspective line drawing of a microfluidic device comprising fluid connection ports of embodiments of the invention;

FIG. 14 shows a cross sectional view from the side of a substrate comprising a fluid connection port of embodiments of the invention;

FIG. 15 shows a perspective view from above of a substrate comprising a plurality of fluid connection ports of embodiments of the invention;

FIG. 16 shows a perspective view of a substrate comprising a plurality of fluid connection ports of embodiments of the invention; and

FIG. 17 shows a perspective line drawing from above of a substrate comprising a plurality of fluid connection ports of embodiments of the invention.

FIG. 18 shows a cross sectional view from the side of a double start (left) and single start (right) threaded fluid connection port of embodiments of the invention as machined with a 500 μm diameter square end-mill.

FIG. 19 shows a microfluidic device used for pressure measurements (top) and a pressure testing apparatus using a Dolomite Mitos™ pump (11 bar max. Operated to 8.4 bar) (bottom).

FIG. 20 shows a schematic of a syringe driven pressure test apparatus.

FIG. 21 shows a cross sectional view of a fluid connection port having an optimal tested configuration for Tygon S-54-HL tubing Ø0.06″ and EVA tubing Ø 1/16″.

FIG. 22A shows a line drawing of the shoulder geometry as machined in the work described herein.

FIG. 22B shows a line drawing of the shoulder geometry with a square shoulder shape formed by injection moulding or hot embossing.

FIG. 22C shows a line drawing of the shoulder geometry with a concave shoulder.

FIG. 23 shows a tubing end compression structure comprising a “corona” structure machined within the 45° chamfer to facilitate insertion of tubing to the port—left: plan view, right: isometric view.

FIG. 24 shows a perspective line drawing of a single start threaded fluid connection port with a tubing end compression structure to facilitate insertion of a tube.

FIG. 25A shows a collet plunger, tubing, and a collet sleeve for a tube insertion tool for the application of a tube to a fluid connection port.

FIG. 25B shows tubing fitted to a collet plunger.

FIG. 25C shows a collet plunger inserted to collet sleeve bore through alignment of flats on plunger with slot in sleeve.

FIG. 25D shows rotation of plunger for concentric engagement of the collet sleeve with the collet plunger.

FIG. 25E shows the tube insertion tool with 2 mm of tubing protruding from the end of the plunger being aligned with a port and the plunger depressed.

FIG. 25F shows the tube insertion tool sleeve is withdrawn to the clearance diameter of the plunger at its middle section.

FIG. 25G shows the tube insertion tool is removed from the tube and port via the aligned slots on both the collet plunger and collet sleeve.

FIG. 26A shows a view from outside (sealed) showing the included chamfered section and corona structure of the fluid connection port with a break-off cap structure.

FIG. 26B shows an isometric view from outside showing internal structure of a fluid connection port with a break-off cap structure.

FIG. 26C shows an isometric view in cross section of a fluid connection port with a break-off cap structure.

FIG. 27A shows an isometric view from beneath in cross-section of the microfluidic structure incorporated into moulding of the fluid connection port with a break-off cap structure.

FIG. 27B shows the side-view cross-section of closed structure prior to opening including microfluidic channel included in moulding at base of the fluid connection port with a break-off cap structure.

FIG. 27C shows the cap structure of the fluid connection port broken out for tube connection.

FIG. 27D shows the fluid connection port with a break-off cap structure with the base of the needle port pierced for application of a droplet or reservoir of sample or reagent.

FIG. 28 shows a perspective view of a needle as it is aligned prior to insertion into a fluid connection port with a break-off cap structure.

FIG. 29 shows a side-view cross-section of a needle inserted into a fluid connection port with a break-off cap structure.

FIG. 30 shows a side-view cross-section of a needle inserted into fluid connection port with a break-off cap structure with the cap structure broken off.

FIG. 31 an example of a microfluidic device having fluid connection ports with a break-off cap structure assembled with tube.

FIG. 32 shows a perspective view of a needle about to perforate a break-off cap structure of a port to administer a droplet dose, pump a sample at low pressure or to use the needle as a reservoir.

FIG. 33 shows a side-view cross-section of a needle about to perforate a break-off cap structure of a port to administer a droplet dose, pump a sample at low pressure or to use the needle as a reservoir.

FIG. 34 shows a side-view cross-section of a needle perforating a break-off cap structure of a port to administer a droplet dose, pump a sample at low pressure or to use the needle as a reservoir.

FIG. 35 shows a perspective view of a needle perforating a break-off cap structure of a port to administer a droplet dose, pump a sample at low pressure or to use the needle as a reservoir.

FIG. 36 shows a line drawing of a fluid connection port in a Leur lock style high pressure fitting.

FIG. 37 shows a line drawing of a fluid connection port in a Leur lock style high pressure fitting with a 3 start thread and a lead-in bore to facilitate insertion and increase resistance to manual removal of tube.

FIG. 38 shows a perspective view of the fluid connection port in a Leur lock style high pressure fitting shown in FIG. 37.

FIG. 39 shows a side-view cross-section of the fluid connection port in a Leur lock style high pressure fitting shown in FIG. 37.

FIG. 40 shows a detailed side-view cross-section of the fluid connection port in a Leur lock style high pressure fitting shown in FIG. 37.

FIG. 41 shows a detailed line drawing of the fluid connection port in a Leur lock style high pressure fitting shown in FIG. 37.

FIG. 42 shows a line drawing of a fluid connection port in a ferrule.

FIG. 43 shows a side-view cross-section of the fluid connection port in a ferrule shown in FIG. 42.

FIG. 44 shows an assembly of the ferrule shown in FIG. 42 and the Leur lock style high pressure fitting shown in FIG. 37 on a tube.

FIG. 45 shows an example of a port reaming process using a reamer and depth setting block.

FIG. 46 shows a detailed view of a port reaming process using a reamer and depth setting block.

FIG. 47 shows a detailed view of a port reaming process using a reamer and depth setting block.

FIG. 48 shows a detailed view of a port reaming process using a reamer and depth setting block.

FIG. 49 shows a detailed view of a port reaming process using a reamer and depth setting block.

FIG. 50 shows a detailed view of a port reaming process using a reamer and depth setting block.

FIG. 51 shows a detailed view of a port reaming process using a reamer and depth setting block.

FIG. 52 shows another end of the reamer having a mandrel to centre the tool and teeth to cut an inclined draft angle.

FIG. 53 shows a detailed view of the inclined draft angle being cut.

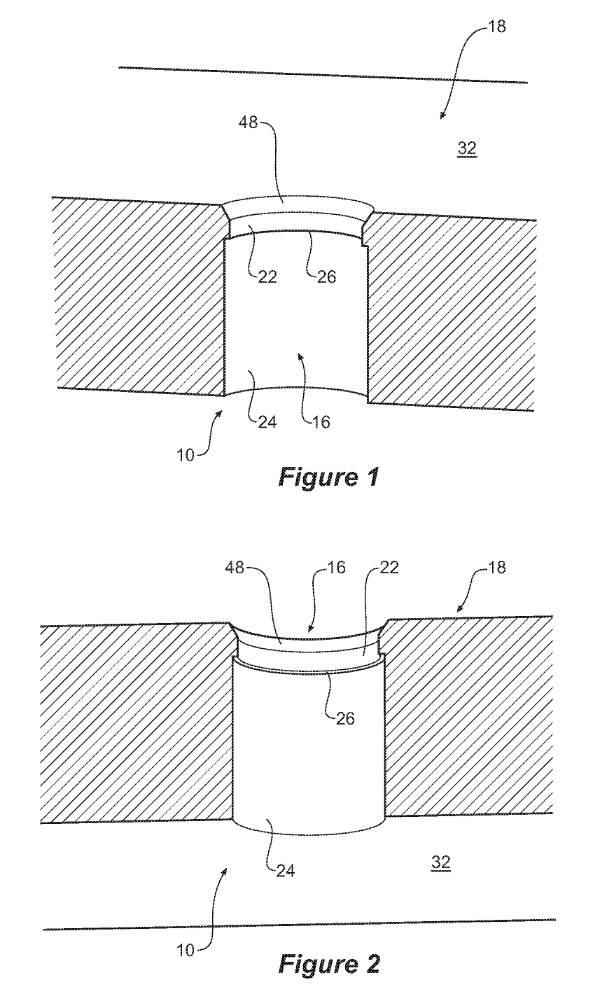

In the following description, like reference characters designate like or corresponding parts throughout the figures.

### DESCRIPTION OF EMBODIMENTS

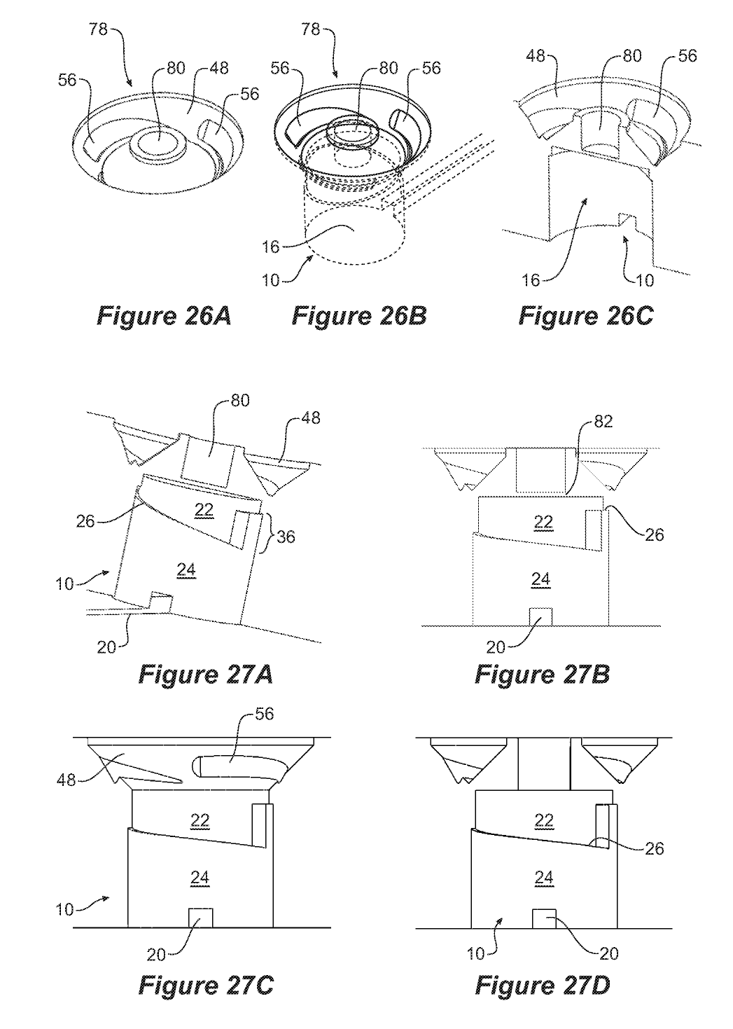

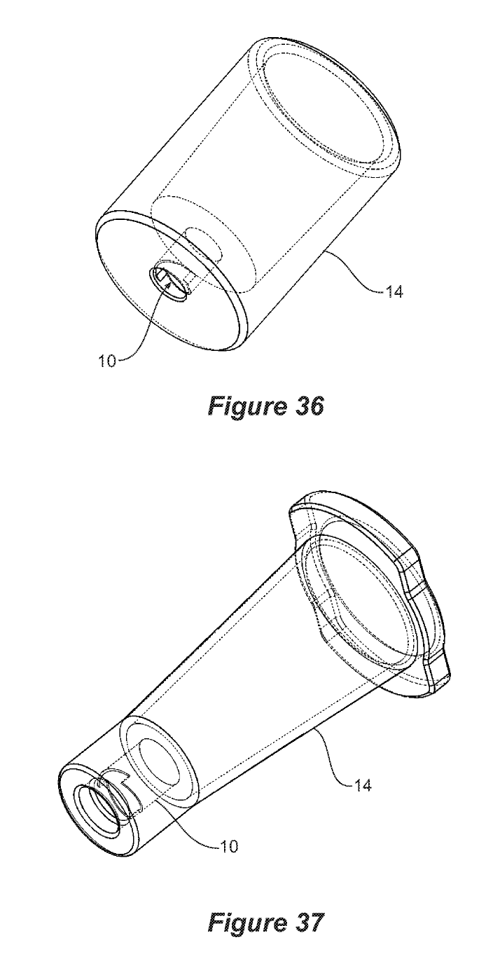

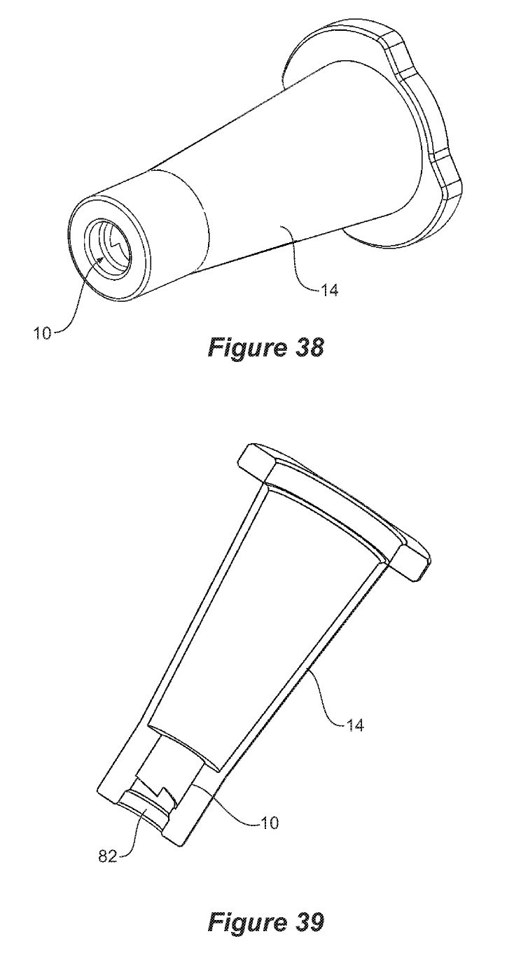

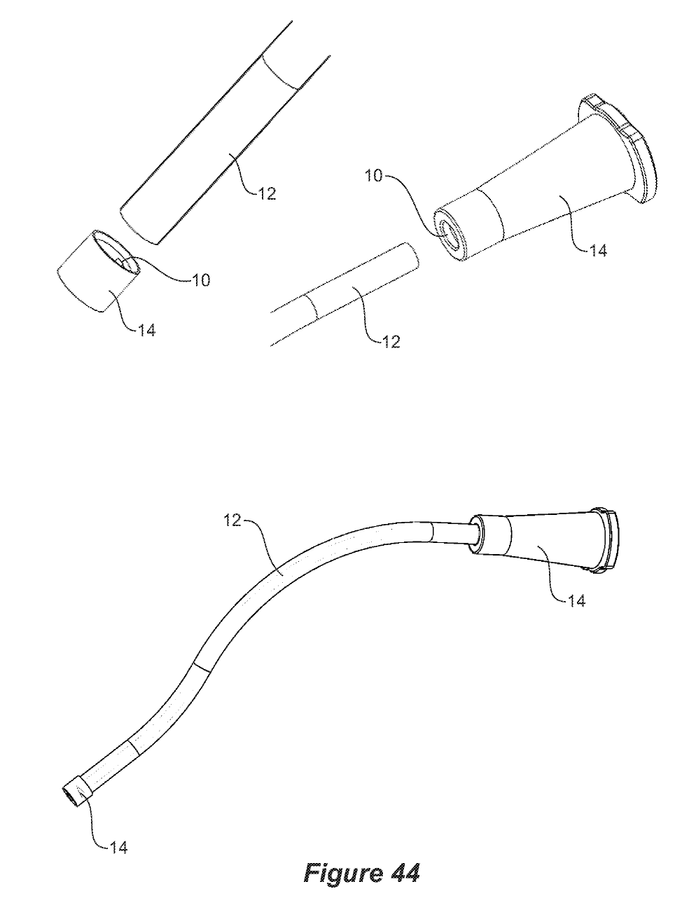

Referring to the figures generally, the present invention provides a fluid connection port 10 for forming a working fluid connection between a deformable, flexible tube 12 and a fluid handling device 14. The fluid connection port 10 may be particularly suitable in the area of microfluidics in which case the fluid handling device may be a microfluidic device as best seen in FIGS. 10, 11 and 13 and described in more detail below. The fluid connection port 10 could also be used in the medical area such as in point-of-care diagnostics and embodiments for this purpose are illustrated in FIGS. 26A-27D and 36-44. Other areas of application for the fluid connection port include chromatography (FIG. 36) and, whilst the following description refers predominantly to microfluidics applications, it will be appreciated that the features of the fluid connection port 10 described in relation to microfluidics can also be applied in other areas.

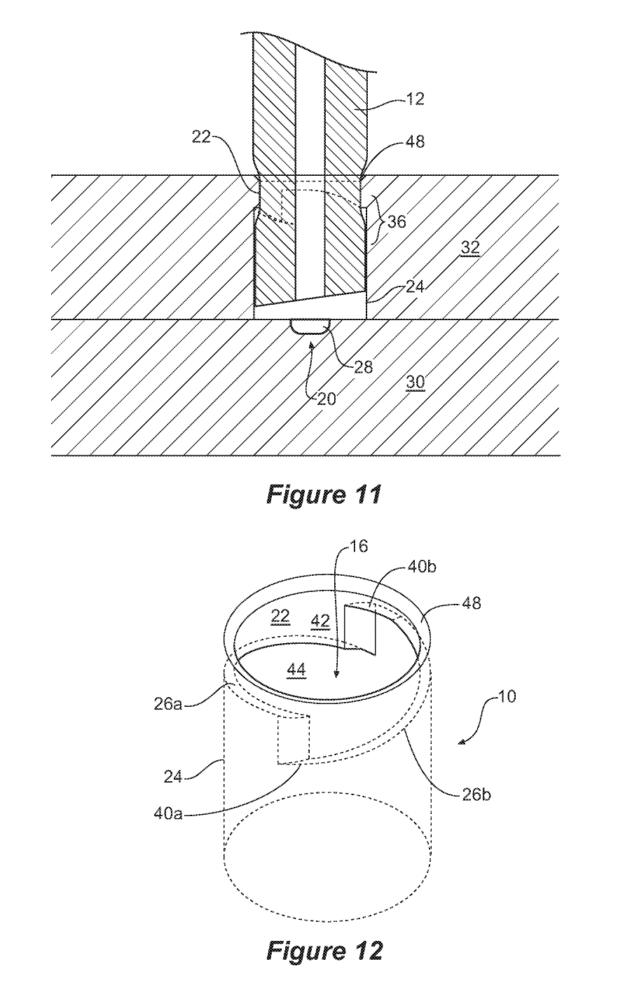

The fluid connection port 10 comprises a bore 16 extending from an exterior surface 18 of the microfluidic device 14 to an internal microfluidic feature 20. The bore 16 comprises a narrow diameter bore section 22 adjacent the exterior surface 18 of the microfluidic device 14 and a larger diameter bore section 24 adjacent the internal microfluidic feature 20. A shoulder 26 separates the narrow diameter bore section 22 and the larger diameter bore section 24. The diameter of the bore 16 at the narrow diameter bore section 22 is less than the diameter of the deformable, flexible tube 12. Optionally, the diameter of the bore 16 at the larger diameter bore section 24 is also marginally less than the outer diameter of the deformable, flexible tube 12. In use, the tube 12 is inserted into the bore 16 and the tube 12 is radially compressed at the narrow diameter bore section 22 thereby forming a seal between the tube 12 and the bore at the narrow diameter bore section 22 as best seen in FIGS. 10 and 11. As the tube 12 extends into the larger diameter bore section 24 it expands radially so that the tube conforms to the inner surface of the bore 16 at the shoulder 26 and maintains a slight pressure on the inner surface of the larger diameter bore section 24 to exclude the possibility of fluid passing between the tube and the bore surface to enhance sealing. In this way, the shoulder 26 acts to retain the tube 12 in the bore 16.

The microfluidic device 14 may be any substrate or apparatus used for the manipulation of fluids on a micro-scale. The device can be used to perform a variety of chemical and biological analytical and chemical techniques. Devices of this type are often referred to as “microchips” or as “lab-on-a-chip” devices and may be fabricated from plastic, glass, silicon, metal, with the channels being etched, machined or injection moulded into individual substrates. Multiple substrates may be arranged and laminated to construct a microfluidic device of desired function and geometry.

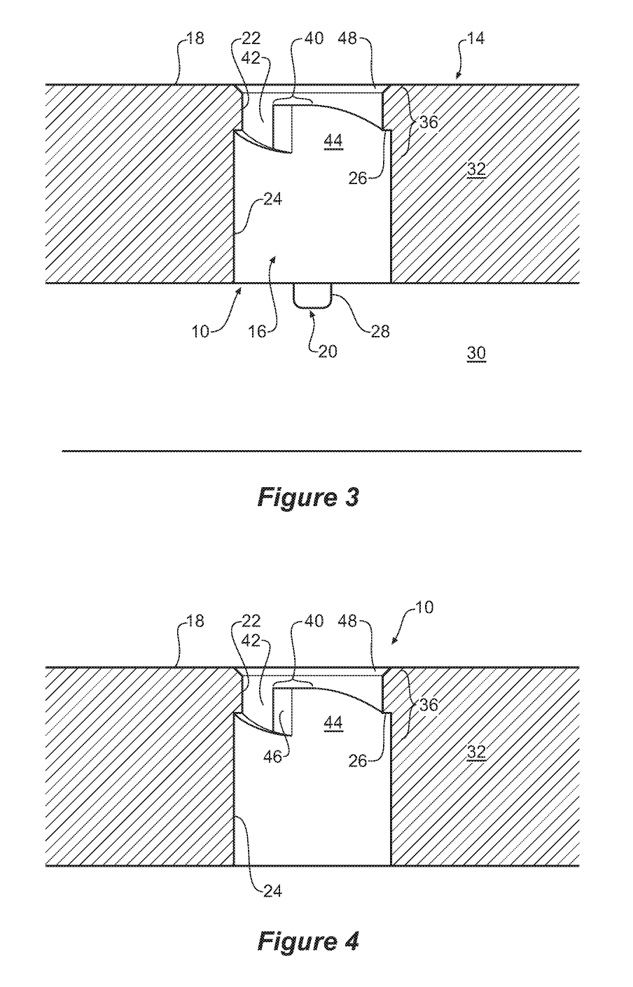

The microfluidic device 14 includes one or more microfeatures 20, such as channels, valves, pumps, and/or reservoirs, for storing fluids, routing fluids to and from various locations on the chip, and/or reacting fluidic reagents. By way of example, the microfluidic device 14 shown in FIG. 3 includes a microfluidic channel 28. The channel 28 can have any cross-sectional shape (circular, oval, triangular, irregular, square, rectangular, or the like). The dimensions of the channel 28 are chosen such that fluid is able to freely flow through microfluidic device 14. The number of channels and the shape of the channels can be varied by any method known to the person skilled in the art.

The microfluidic device 14 comprises a first substrate 30 and a second substrate 32. The microfluidic channel 28 is fabricated within the first substrate 30. It is also possible to form a corresponding microfluidic channel on the underside of the second substrate 32 whereby the channels on the first substrate 30 and second substrate 32 form a common channel when the substrates 30 and 32 are bonded together. The fluid connection port 10 is formed in the second substrate 32 and comprises a bore 16 passing therethrough. One or more fluid connection ports 10 can be formed in the second substrate 32 so that the bore 16 is aligned or otherwise in fluid connection with the microchannel 28 or other microfeature in the first substrate 30 when the substrates are bonded together to form the microfluidic device 14. The substrates 30, 32 are bonded or otherwise fixed to one another in a sandwich arrangement. The fluid connection port 10 may be and inlet port or an outlet port.

An embodiment of a microfluidic device 14 shown in FIG. 13 comprises a plurality of microfluidic channels 28a, 28b. The channels 28a, 28b can have any cross-sectional shape (circular, oval, triangular, irregular, square, rectangular, or the like). The dimensions of the channels 28a, 28b are chosen such that fluid is able to freely flow through microfluidic device 14. The number of channels and the shape of the channels can be varied by any method known to the person skilled in the art.

The fluid connection port 10 may be formed by direct machining or injection moulding. For example, one or more fluid connection ports 10 may be formed in the second substrate 32 by direct machining, injection moulding or hot embossing and the second substrate 32 may then be aligned with the first substrate 30 containing the required microfluidic features 20 and the two substrates hot bonded or otherwise adhered. Alternatively, the microfluidic features 20 and ports 10 may be formed in a common substrate 32 through an injection moulding process for example and another plain or structured second substrate 30 applied to thereby seal the microfluidic features 20.

In use, an end of the tube 12 is connected to an inlet fluid connection port 10. The other end of the tube 12 may be connected to a source of fluid and/or a pump. A variety of tube types are known for this purpose in the art. In each case, the tube 12 is deformable and flexible. Suitable materials include silicone, rubber, Tygon, EVA, PTFE, PVC, etc. The tube 12 may also be a tube of a hard material such as glass, with a deformable polymer sheath such as those often used in chromatography. The deformable, flexible tube 12 may have a diameter of from about 0.3 mm to about 2 mm. We have found that deformable, flexible tube 12 having a diameter of about 1.2 mm to about 1.6 mm is effective.

An advantage of the fluid connection port 10 of the present invention is that the tube 12 does not need to be modified in order for it to be connected to the microfluidic device 14. For example, the tube 12 does not contain a threaded section and does not need to have anything added to it for it to be used with the fluid connection port 10. Thus, we refer to the tube 12 as having a “substantially smooth outer surface” which means that the outer surface of the tube 12 is not modified and/or does not contain threads, protrusions or other surface features to engage with the internal wall of the bore 16. Similarly, the same form of tube 12 can be connected to an outlet port 10.

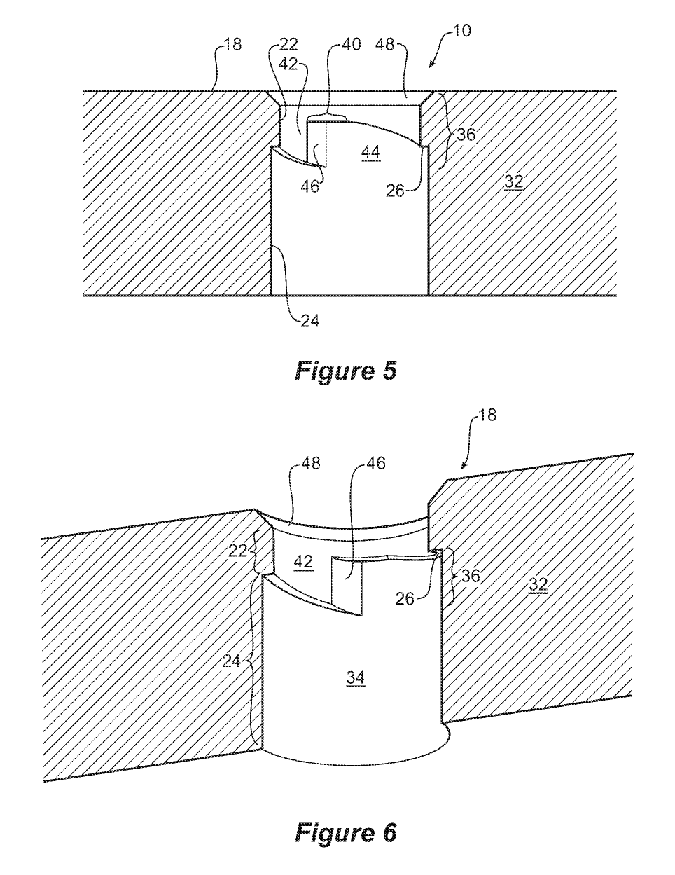

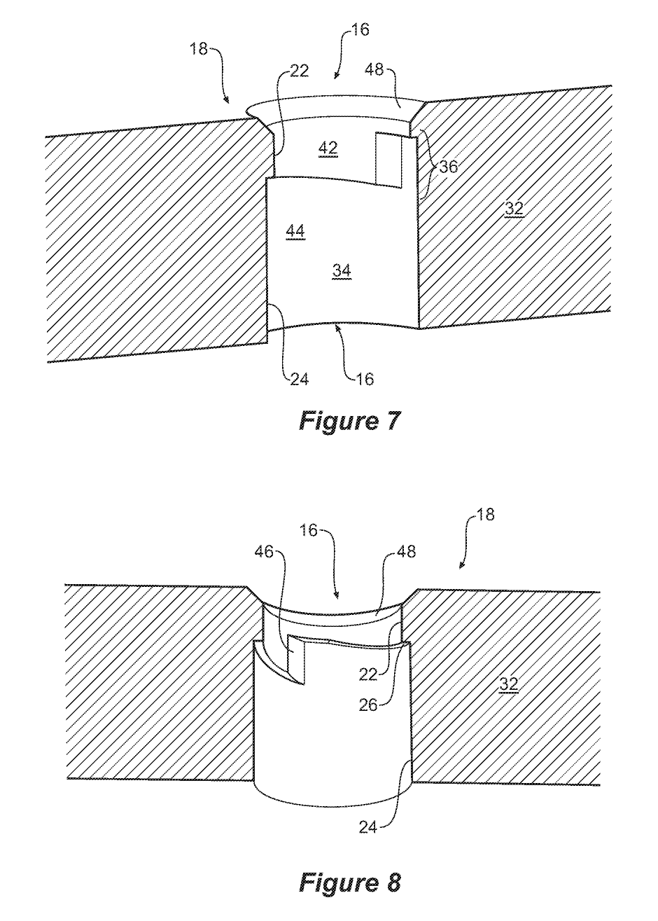

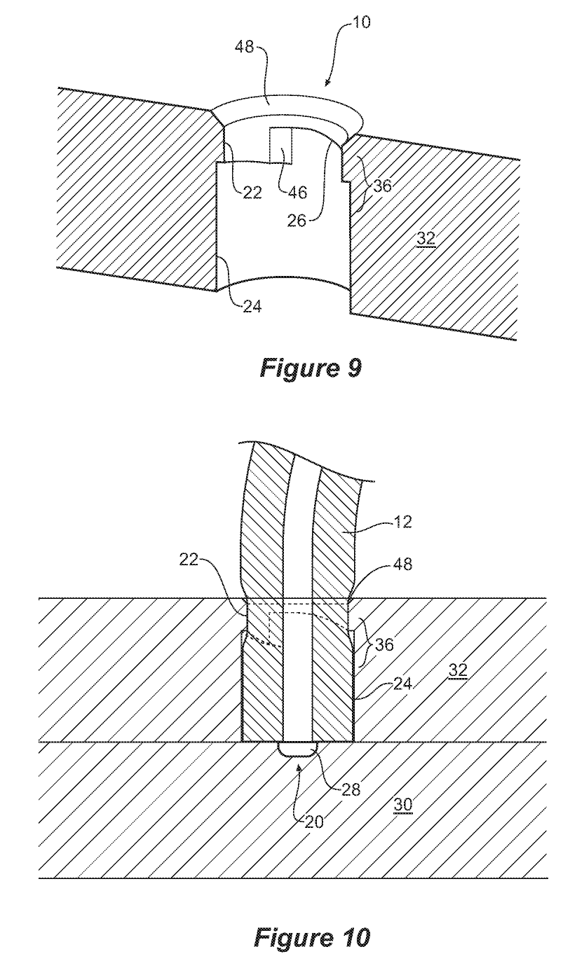

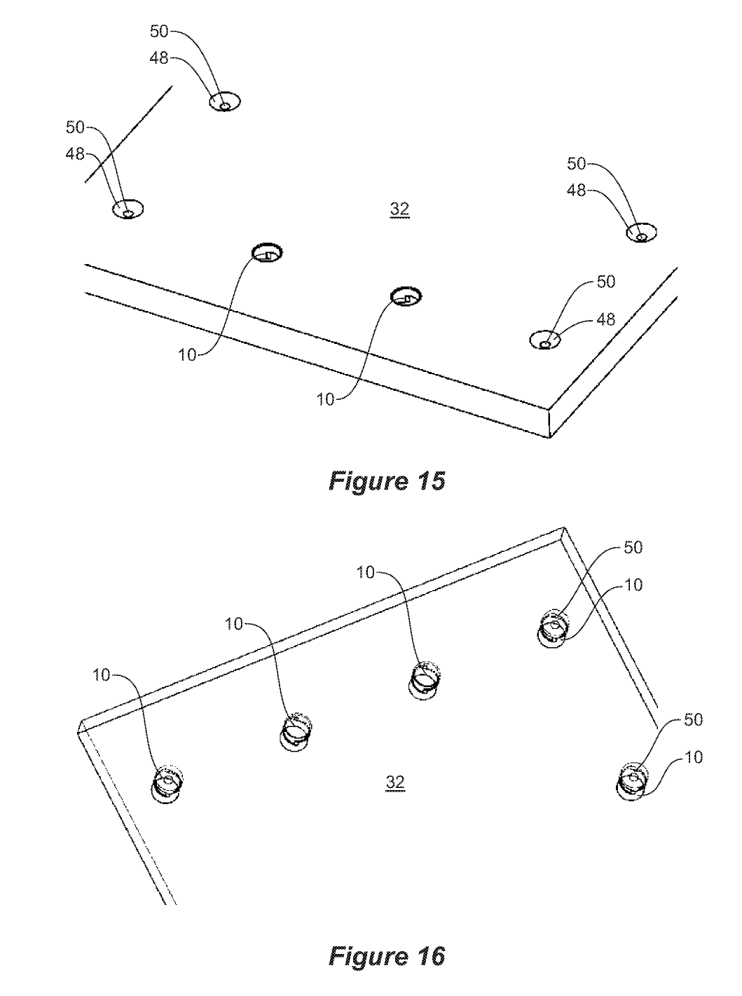

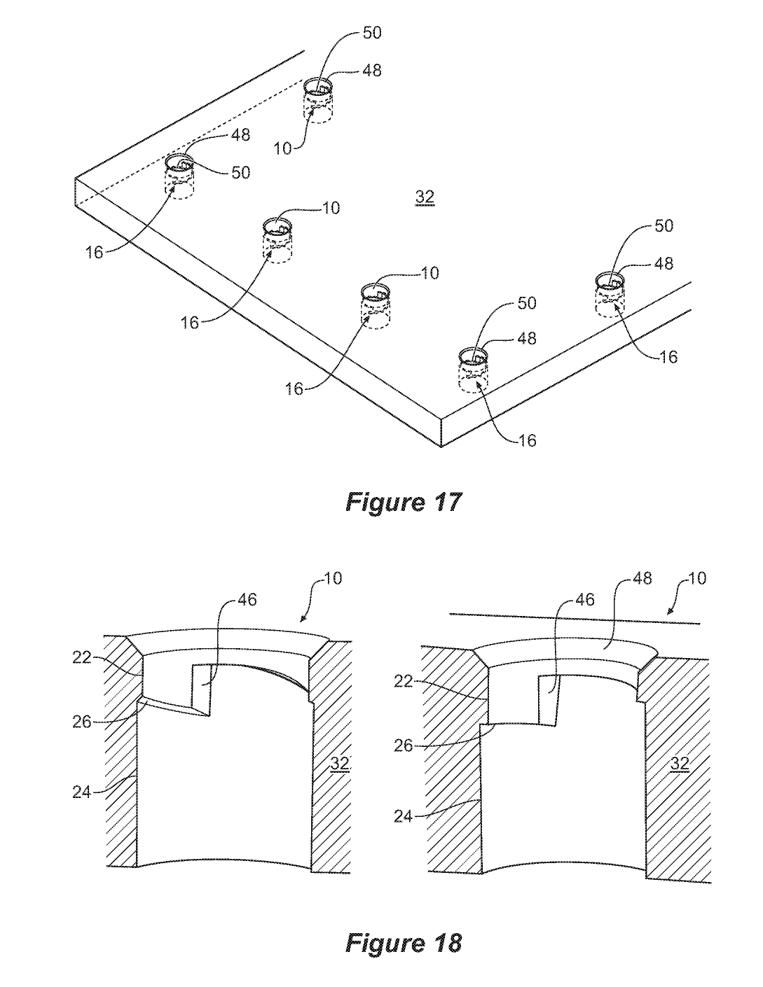

In embodiments illustrated in FIGS. 3 to 18 an internal wall 34 of the bore 16 comprises a threaded section 36. At the threaded section 36 the shoulder 26 is helically wound so as to form a thread. In embodiments shown in FIGS. 3 to 11 and 13 to 16 the shoulder 26 extends around the inner surface of the bore 16 by about 360 degrees. As such, the thread is a single turn thread. The ends of the shoulder 26 are spaced from one another longitudinally along the bore 16. The spacing between the ends of the shoulder 26 (i.e. the start and end of the thread) may be about 10 to about 50% of the diameter of the tube, dependent on the physical properties of the tube to be used.

The threaded section 36 does not extend the full length of the bore 16 as if it did it would not be possible to form a seal between the tube 12 and the narrow diameter bore section 22. Instead, the threaded section 36 is bound at one end by the narrow diameter bore section 22 and at the other end by the larger diameter bore section 24.

The helically wound shoulder 26 starts and ends at a toothed section 40. The toothed section 40 comprises a reduced diameter wall 42 and a larger diameter wall 44 with a web 46 extending between the two walls 42, 44. The web 46 is angled obliquely with respect to the internal wall of the bore 16 with the reduced diameter wall 42 overlaying the larger diameter wall 44 when viewed from inside the bore 16. The helically wound shoulder 26 effectively bites into the tube 12 and this assists in the insertion of the tube 12 when the tube 12 is rotated in the appropriate direction. In the illustrated embodiments, a clockwise rotation of the tube 12 will drive the tube 12 in the direction towards the larger diameter bore section 24 of the bore 16.

In alternative embodiments, the threaded section 36 comprises a multiple start thread. For example, the threaded section 36 may comprise a double, triple or quadruple start thread. A double start thread is illustrated in FIG. 12. In these embodiments, the shoulder 26 is in the form of two separate shoulder sections 26a, 26b, with each shoulder section 26a, 26b extending around the inner wall of the bore 16 by about 180 degrees. The shoulder sections 26a, 26b start and end at a common toothed sections 40a, 40b. The configuration of the toothed sections 40a, 40b and shoulder 26 in each shoulder section 26a, 26b is as described previously. Thus, the shoulder 26 can incorporate a series of toothed sections, thereby resembling a multiple start thread.

The higher the number of threads in the threaded section 36, the greater the draft angle of each thread and, therefore, the further the tube 12 is drawn into the bore 16 per angle of turn. Alternatively, the pitch may be reduced to decrease this draft angle. A single start thread will have one x pitch, a double start thread will have a 0.5x pitch, a triple start thread will have a 0.33x pitch, etc. The number of threads that can be used in the bore 16 will be limited by the thickness of the substrate 32 through which the bore 16 passes, bearing in mind the requirement to have the larger diameter bore section 24 below the threaded section 36. In embodiments, the length of the larger diameter bore section 24 is about half its diameter so that the tube 12 has adequate space to expand into the larger diameter bore section 24.

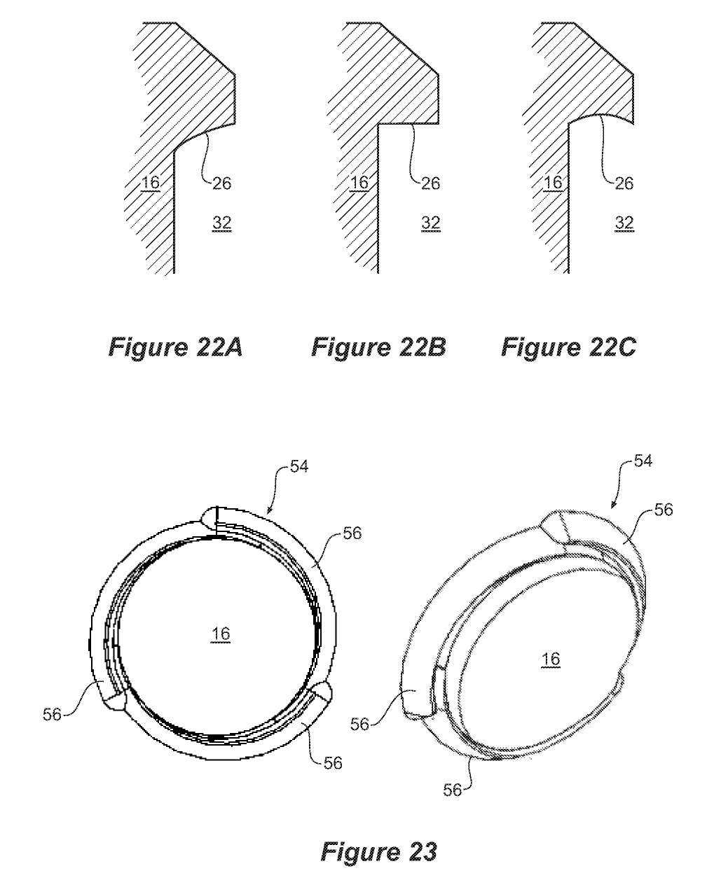

In practice, when a 0.5 mm diameter end mill is helically interpolated to generate the screw-shoulder features of the threaded section 36, the attitude of the square-ended cutter produces a small draft on the shoulder 26 (making it less acute) and this is more evident for the double start thread than for the single start due to the helix angle. These geometries are shown in FIGS. 18 and 22A-22C.

When the tube 12 is inserted into the bore 16, the threaded section 36 bites into the outer surface of the tube 12. Twisting the tube in the threaded section 36 then drives the tube 12 deeper into the bore 16. As the tube 12 passes the threaded section 36 and into the larger diameter bore section 24 any compressive forces placed on the tube 12 by the narrow diameter bore section 22 and/or the threaded section 32 may be at least partially relieved and the tube 12 may expand into the larger diameter bore section 24. In this configuration, the shoulder 26 catches the outer surface of the tube 12 when any force is applied to the tube 12 in a direction away from the microfluidic device 14 (which force may result from a person pulling the tube in that direction or from the pressure of the fluid in the tube and microfluidic device) and opposes that force. In practice, the tube 12 is easier to insert into the bore if the end of the tube 12 to be inserted is cut at a slight angle as shown in FIG. 11 since the angled tip of the tube can engage with the threaded shoulder 26 structure and the tube suitably rotated to facilitate insertion. However, it may not be possible to form a face seal between the end of the tube 12 and the first substrate 30, as discussed in more detail later.

An edge of the shoulder 26 may also be angled so it bites into the outer surface of the tube 12.

As best seen in FIG. 10, an effect of threaded section 36 driving the tube 12 into the bore 16 is that it assists in compressing the end of the tube 12 along its axis to form a face seal with the first substrate 30 at the base of the bore 12. This results in the formation of a very high pressure and zero dead volume fluid connection port 10.

The top of bore 16 at the exterior surface 18 of the microfluidic device 14 is chamfered. The chamfered section 48 allows easier insertion of the tube 12 into the bore 16 as it tends to centralise the tube 12 toward the entrance to the bore 16.

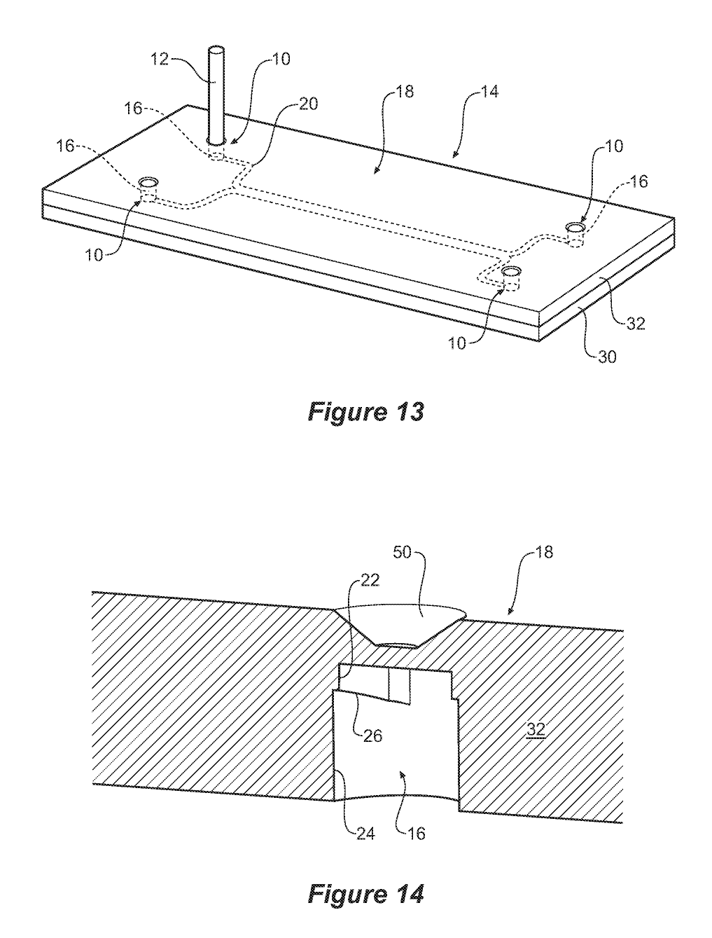

In embodiments shown in FIGS. 14 to 17, the bore having shoulder 26 and, optionally, threaded section 36 is formed from the lower surface of the second substrate 32 of microfluidic device 14 but the bore 16 is not formed all the way to the exterior surface 18. Instead, the opening of the bore 16 at the exterior surface 18 is closed by a thin web 50 and a chamfered section 48 which serves to indicate that a bore 16 is located at that position on the substrate 32. As seen in FIGS. 14 to 16 the second substrate 32 may have a plurality of bores 12 of this type positioned on the substrate 32 so that a user can drill through the chamfered section 48 and web 50 to form a working bore 16 at any of the predetermined locations on the device 12. Thus, the second substrate 32 could be drilled in the required locations to open a bore 16 with the correct geometry as a post-operation. A drill that is the diameter of the narrow diameter bore section 22 can be used for this purpose. The presence of the chamfered section 48 serves as a centre, or spot-drilling mark in the correct location so that simple or hand tools may be used by the operator to drill out the web 50, thus opening the bore 16 and forming a working bore with the correct geometry according to the embodiments previously described. The widest part of the chamfered section 48 will remain after the drilling operation, thus forming a small chamfer 48 at the top of the narrow diameter bore section 22. Such a process may be used to fabricate generic substrate “lids” to be used with multiple microfluidic devices, or to make fluid connections to different sections of a generic microfluidic chip i.e. connecting fluids only to those parts of a microfluidic structure that require fluid supply or extraction for a given purpose.

To test the pressure capacity of the fluid connection port 10 a number of ports with different geometries were formed. In a single substrate 32, a plurality of fluid connection ports 10 was formed. The plane where the shoulder 26 commenced was kept the same across all ports 10, with the z-offset from the exterior surface 18 of the substrate initially set at 0.1 mm. As each sample was machined, the chamfered section 48 on the exterior surface 18 was cut by hand with a 90 degree included angle chamfer tool. The plane from which the shoulder 26 was created was shifted further from the exterior surface 18 each machining run, with inspection by microscope in between each until sufficient length was left on the smaller diameter bore section 22 which communicates with the exterior surface 18 so that an adequate chamfer to facilitate tube 12 insertion could be achieved. After the machining of ten individual devices 14, each with 16 individual ports 10, it was determined that a depth for the commencement of the shoulder 26 structure of 0.3 mm was suitable.

Initial pressure testing was conducted by inserting a tube 12 into each port 10, then sealing off the other side of the substrate using a microfluidic chip holder. Air was then forced into the tube 12 via either a 1 mL or 5 mL syringe to the maximum capacity of the Luer Lock. The tube side of the port 10 was flooded with gas leakage detector (a water and surfactant solution) to make obvious any leakage of the pressurized gas. The dead volume of the syringe, tube and port structure was accurately calculated by a water mass measurement. By measuring the volume of the syringe at 1 Atmosphere (6 mL) and at the peak of compression (0.2 mL), and accounting for dead-volume in the system, the approximate pressure in the system at full compression was calculated. The maximum calculated pressure that could be achieved reliably was approximately 4.2 MPa, or 42 bar. In each case, the syringe plunger was allowed to spring back to its initial volume at atmospheric pressure to demonstrate that no air had leaked. In each case, the plunger sprung back to its approximate starting point. These tests showed that the pressure tolerance of all of the ports 10 was in excess of approximately 4 MPa. It was also observed that the sealing function occurred, with the inserted part of the tube 12 expanding into the larger diameter bore section 24 beneath the shoulder 26, thereby forming the seal.

Different diameter bore sections were also tested. To do this a device was fabricated with two rows of eight ports 10. Vertically aligned ports 10 had the same diameter in the smaller diameter bore section 22, but the uppermost port 10 of each pair had a smaller diameter larger diameter bore section 24 (1.53 mm) compared to the lowermost port of each pair which had a larger diameter in the larger diameter bore section 24 (1.55 mm).

On devices having a threaded section 36 in the ports 10 some threaded sections 36 were double start threads and others were single-start. The diameter of the smaller diameter bore sections 22 increased from 1.36 mm to 1.44 mm across in each row of ports 10. The diameter values were calculated on the measured dimensions of commercial 1/16″ OD tube 12 to provide reasonable compression inside the smaller diameter bore section 22, without causing occlusion of the 0.020″ bore of the tube 12. As discussed, the diameter of the larger diameter bore section 24 was set at either 1.53 mm, to provide subtle compression of the tube, or 1.55 mm (bottom row) to achieve the largest possible shoulder, without adding dead volume to the port 10.

Usability scores were recorded for each of the port geometries, initially for insertion of the commonly used tube in the medical field, Tygon®, capillary tube S-54-HL (Saint-Gobain, distributed by Cole-Palmer). This tube is a PVC tube with a very low elastic modulus, 4.48 MPa and 320% ultimate elongation. These characteristics make it very flexible and suitable for medical use, but also the most difficult to handle for fitment to microfluidic screw-ports.

Usability was scored subjectively, testing ports with tube cut at angles of 0° (perpendicular cut), 15°, 30° and 45° from the perpendicular. It was determined that the 30° cut tube 12 provided the easiest insertion. However, the possibility of a face-seal was usually not available since too much of the end of the tube 12 had to be compressed, and may in some cases occlude the end of the tube 12. The 30° tube cut was therefore excluded from subsequent tests. Nevertheless, the fact that this cut angle still allowed high (4 MPa approx) pressure sealing with a relatively deep port 10 (in a 2 mm thick substrate) means that this cut angle may still be used for a high quality seal in instances where a face seal is to be avoided, such as where the microfluidic geometry is injection moulded into the same part as the ports 10.

It was also noted that the larger the cut angle of the end of the tube 12 and the shallower the port 10 (i.e. the thinner the substrate) the easier it was to manually withdraw the tube 12, which would lead to a greater risk of inadvertent removal of the tube 12. The 40° cut tube 12 was more difficult to use, since the angled point of the tube 12 was able to deflect too readily, meaning that the shoulder 26 did not sufficiently bite into the side of the tube 12 to cause draw-in (i.e. the pulling action imposed by the threaded sections 36 upon clockwise twisting of the tube 12). The 40° cut tube 12 was not used in further tests, but it may be useful for machine insertion into a port 10 having a straight shoulder 26 in instances where the port 10 is made sufficiently deep through use of a thicker substrate.

A second batch of devices 14 was then formed to accurately machine the chamfered section 48 to obtain ideal dimensions for the chamfer After three iterations of a 45° chamfer at different depths, it was determined that for a shoulder 26 depth of 0.3 mm, the ideal depth of chamfer was 160 μm. This created a smaller diameter bore section 22 that at its thinnest point was 140 μm. This also added 280 μm to the diameter of entry to the port 10, which for all of the port diameters added sufficient diameter to the chamfered section 48 that the outer diameter of the tube 12 was exceeded (chamfered section 48 diameter for the 1.36 small bore was 1.68 mm) and the whole circumference of the end of the tube 12 could engage with the surface of the chamfered section 48, rather than the planar exterior surface 18 of the microfluidic device 14. Increasing the depth of the chamfered section 48 made for easier insertion of the tube 12 because the depth of the shoulder 26 in the bore 16 was less and the tube 12 had to span less length to engage with the shoulder 26. Furthermore, the higher pressure in the smaller diameter bore section 22 between the tube 12 and the internal wall 34 would be expected to increase the pressure capacity of the port 10.

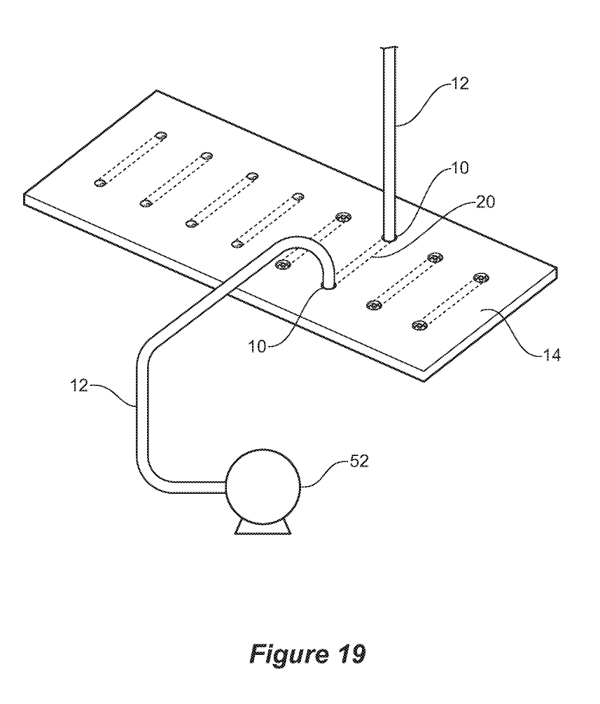

For further pressure testing, devices were machined with a range of port 10 configurations and dimensions, with bases then machined with 520 μm wide×200 μm deep fluidic channels 20 connecting a pair of ports with the same small-bore dimension (FIG. 19). In order to measure the performance of the ports 10 against a standard means of pressure application in conventional microfluidics, each port configuration was connected by both Tygon™ tube and EVA tube purchased from Cole-Parmer to a commercial microfluidics pressure pump 52 (Mitos™, Dolomite Microfluidics, UK). One of the communicating ports 10 was connected to the pressure pump, with another tube 12 fitted to the corresponding port 10 at the other end of the channel 20. The tube 12 on the exit side was occluded by tying a knot, hence closing the circuit and permitting pressure to build up throughout the hydraulic system as pressure was applied.

Isopropanol was used to fill the microfluidic channels 20. Isopropanol wets the surface of PMMA more freely than water does, which has an equilibrium contact angle of around 77° as opposed to approximately 15° for isopropanol. The port 10 should be more likely to fail or leak when filled with a liquid that has a stronger interaction with the port surface.

Pressure was systematically applied to ports of all geometries with both Tygon and EVA tube. Initially pressure was set at 200 mbar (200 kPa approx.) and the pressure was increased incrementally to a maximum of 8.4 Bar. All of the ports 10 were able to withstand this pressure apart from the few “post-drill” samples that were drilled either by hand, or very crudely with a 1.4 mm drill mounted in a high speed rotary engraving tool. In these samples, the very poor surface finish and scoring in the crudely drilled neck of the port allowed pressurized isopropanol to leak slowly from the point sources created by the scoring. This was evident under an optical microscope at pressures as low as 300 mbar but leaking only occurred from these point-sources. The post-drill geometry was successfully tested where the drilled bore 16 had been created by accurate circular-interpolation milling In this case, all ports 10 withstood the 8.4 bar maximum. A port 10 with a 1.42 mm diameter post-drilled bore 16 was left at this maximum pressure for 6.5 hours and no leakage was detected.

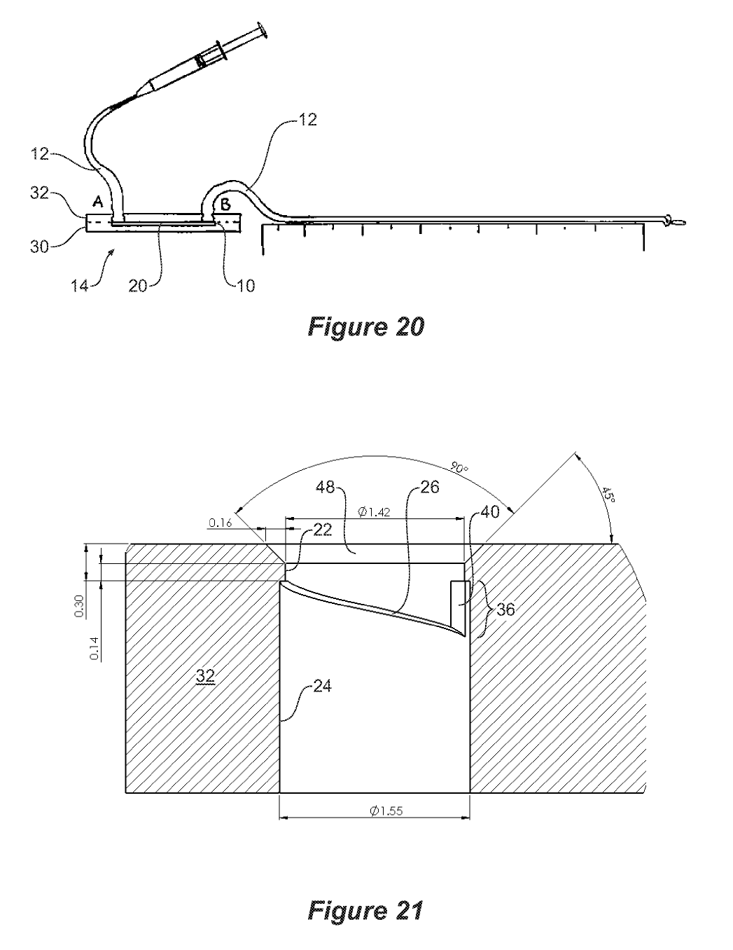

Since the maximum pressure capacity of the commercial pressure pump was reached, another method was devised to test the performance of ports to a far greater pressure. This method is shown in FIG. 20. Tube 12 was inserted into ports 10 with a communicating channel 20. Water was injected into the inlet port 10 and through the channel 20 to the point where it emerged from the exit port 10. This was performed at atmospheric pressure and the end of the exhaust tube 12 300 mm away from the port was tied tightly to occlude it. Points were then accurately marked half way along the length, ¾ along the length, ⅞, 15/16, 31/32 and 63/64 along the length of the tube. As the syringe was depressed, compressing the air space within the tube, each halving of the volume represented a doubling of the internal pressure. Therefore when the liquid reached the first, half-way mark, the internal pressure of the system was 2 bar. At the next mark the pressure was 4 bar etc. This was performed slowly over about 10 seconds for all port geometries until the failure of either one of the microfluidic ports or another part of the system. The maximum pressure achieved during this series of tests was limited only once by the failure of a port 10. This was for the largest bore (1.44 mm) in a thin 1.5 mm thick machined device 14 and 15 degree tube cut angle. In all other cases, the maximum attainable pressure was limited by the failure of other points of connection in the system, such as the Leur-Lock on the syringe or in some cases, the delamination of the bond line between the first 30 and second 32 substrates of the microfluidic device 14. The burst pressure recorded for the weakest port (1.44 mm) was slightly greater than 64 bar (6.4 MPa). This is vastly in excess of the pressure required for most microfluidic applications.

Further pressure tests were conducted through a channel 20 connecting two ports 10 with the same smaller diameter bore section 22 but different diameter larger diameter bore sections 24. For one example of port failure under high pressure (64 bar), it was not the port 10 having the larger 1.55 mm larger diameter bore section 24 that failed, but the port with the 1.53 mm larger diameter bore section 24. This suggests that a wider shoulder 26 is important to the pressure capacity of the ports 10 and that the mode of failure was the inability for the shoulder 26 to grip the tube 12. It was evident under microscopic inspection that the longitudinal compression of the tube 12 under draw-in conditions causes the diametric expansion of the tube 12 into the larger diameter bore section 24, increasing the purchase of the shoulder 26 on the tube 12 and causing a seal on the periphery.

To determine whether the compression set value for Tygon tube (33% when tested at 70° C. for 22 hours) would affect the long-term use of the ports which relies on the expansive force of the elastomer as well as the fluid within it, the ability of the ports 10 to seal over a period of 3 days was tested by allowing a freshly-made connection to age for the same period. Using the initial air-pressure sealing method with a syringe and leak-evident solution, the freshly made connection was tested to 4.2 MPa. This was repeated after a period of 3 days of rest with the assembly maintained at 21° C. After three days, the port 10 still sustained the maximum 4.2 MPa, even though a slight impression was left in the tube 12 on removal from the port.

Pressure testing with EVA tubes 12 showed that the tubes were extremely easy to use due to the higher Young's modulus (lack of flexibility) and low coefficient of friction of EVA. A sufficient pressure to burst a connection was never achieved in the tests.

In summary, in virtually all of the port 10 configurations tested, even for the thinner 1.5 mm substrate, which presents a shallower port 10, a pressure comparable with the safe working pressure of a common medical and microfluidic supply tube was reached before failure of another part of the circuit.

A particular configuration and dimension for the port 10 was determined that could be easily used by hand, by an inexperienced operator yielding a reliable connection. This was a double start threaded port 10 with a shoulder 26 depth of 0.3 mm, a 45° chamfer of 0.16 mm, a smaller diameter bore section 22 diameter of 1.42 mm and a larger diameter bore section 24 diameter of 1.55 mm for Tygon S-54-HL tube 0.06″ with a 0.02″ capillary bore. This particular port is shown in FIG. 21.

The ports 10 described herein are suited to hot embossing or injection moulding without the need for complex, cored cavity moulds. This means that they can be included into injection-moulded microfluidic (or other connection) devices with minimal tooling expense. The performance of such moulded parts is likely to be superior to the structures tested due to a better achievable surface finish inside the port and a square (or indeed negatively raked or concave) shoulder geometry (FIGS. 22A-22C).

Slight leaking could be induced at 8.4 bar by pulling the tube 12 at an angle perpendicular to the axis of insertion. This motion compressed the tube 12 against one side of the port 10 and a small gap could be opened between the tube 12 and the internal wall of the bore 34 on the other side of the port 10. This is unlikely to present a problem in most situations for a brief application of such a force. However, applying a larger load (around 10-15 N) caused the flexible tube 12 to extrude and deform such that it pulled out of the port 10. However, this was less of a problem for ports 10 with a straight shoulder 26 which required at least five times this load to dislodge. For this reason, the straight shoulder version is most suited to tooled insertion of the tube 12 where devices or connectors are distributed with pre-connected tube (desirably, without the need for adhesives, o-rings, washers or other fixings which add expense, dead-volume and may cause contamination issues). The added strength of the straight shoulder form of the ports 10 in comparison to the threaded shoulder forms may be due to the negative-rake shoulder of the latter and shown in FIGS. 22A-22C and the problem may be avoided, or made insignificant in embossed or moulded versions of the port 10.

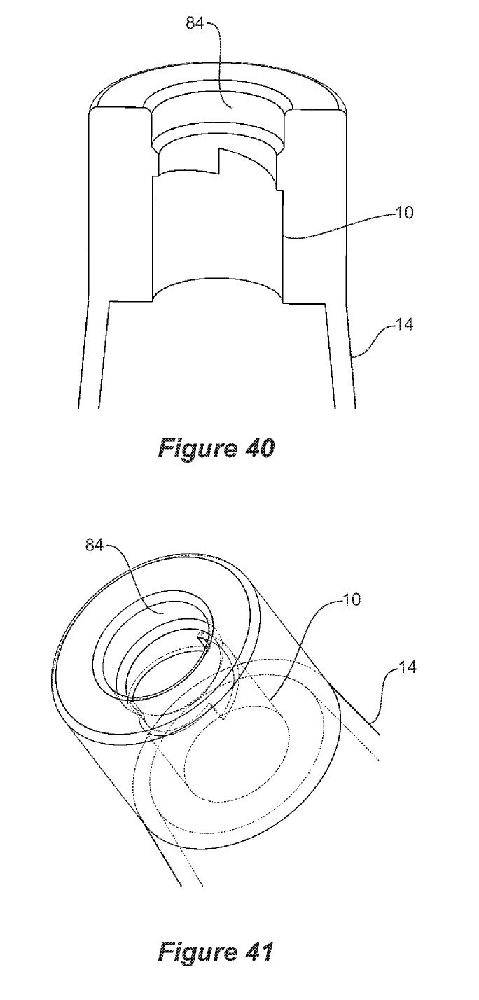

As illustrated in FIGS. 40 and 41, the thickness of a substrate 30 or device 14 incorporating a port 10 may allow for the incorporation of a lead-in bore 84 between the exterior surface 18 of the substrate 30 or device 14 and the entry to the bore 16. The lead-in bore 84 may facilitate insertion of the tube 12 as well as serving to translate laterally applied load to the tube 12 into axial load through the port 10 and make inadvertent removal of the tube 12 or induction of leakage less likely.

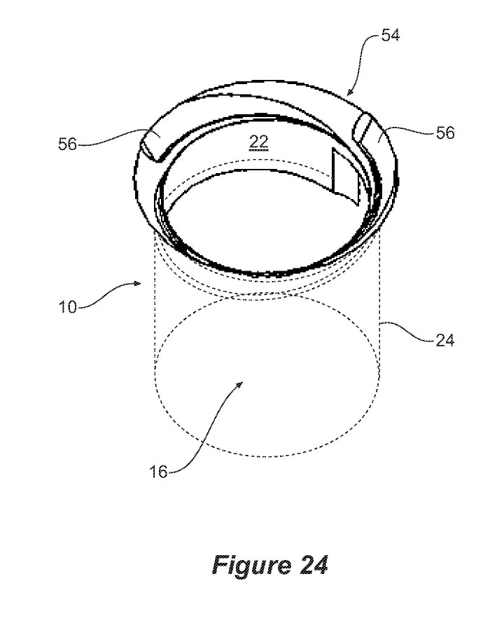

To further facilitate insertion of the tube 12 into the port 10, the geometry of the outside, entrance part of the port 10 may include a tube end compression structure 54 (FIGS. 23 and 24). The tube end compression structure 54 is in the form of a “corona” around the chamfered section 48. The corona 54 comprises three equally spaced features 56 with a steeper chamfer angle (30 degrees) positioned radially from the centre of the port 10 and equally angularly spaced. The curvature of the features 56 is such that they engage with the periphery of the tube 12 and compress it radially as it is turned in a clockwise direction, that is, the same direction required for engagement with the threaded section 36. The features 56 may be machined within the 45 degree chamfered section 48.

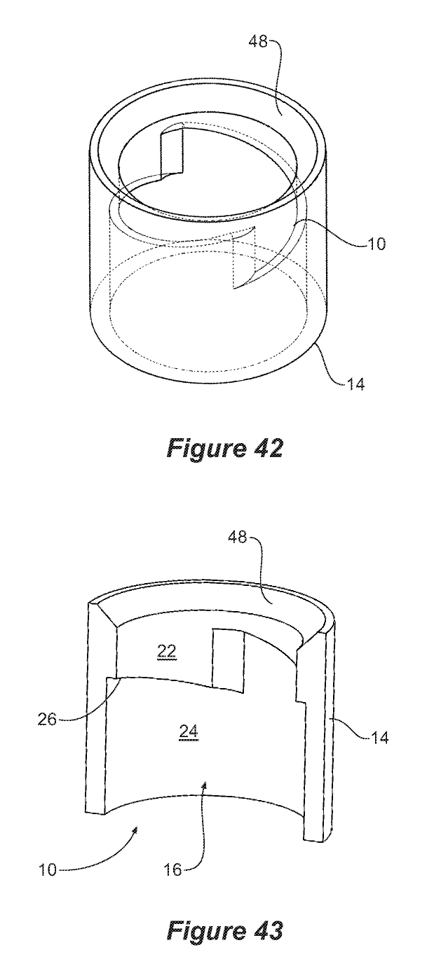

In practice, it was observed that the tube end compression structure 54 facilitated the insertion of 15 degree cut tube 12 to some extent and vastly for the square-cut tube 12. Indeed, the structure 54 made hand insertion easy to perform with square-cut tube 12 which may have otherwise been more difficult. Square-cut tubes 12 made for a tube fitting that was more resistant to withdrawal and most effectively enabled face-sealing. The presence of a face-seal would be expected to increase the pressure capacity of the port 10 connection dramatically and produce a desirable zero-dead-volume connection. This face-seal may also be used to form temporary seals on flat surfaces using variations such as the ferrule shown in FIGS. 42 and 43.

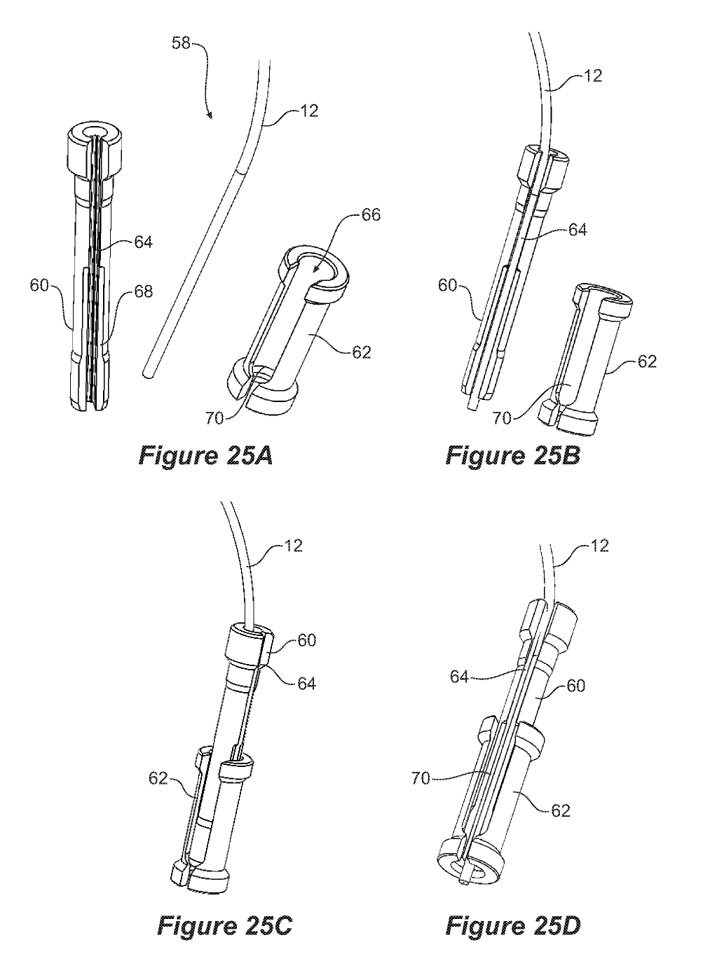

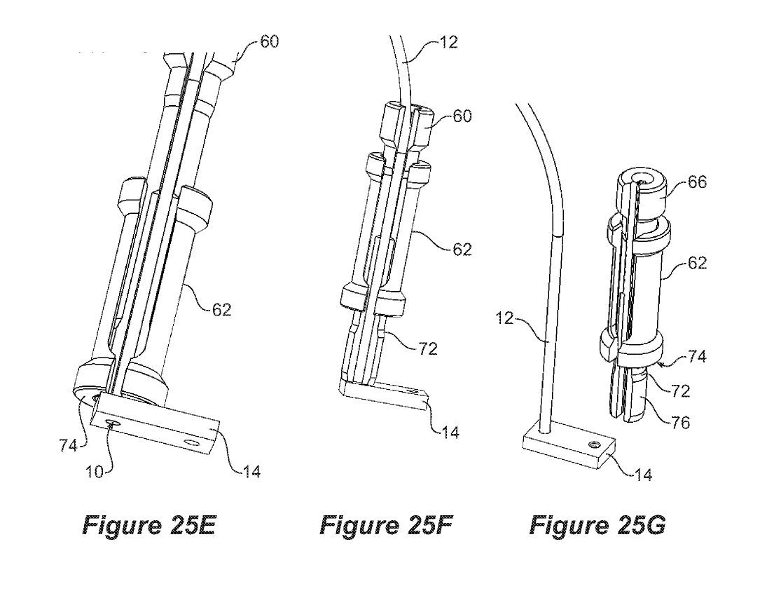

A suitable tool 58 may be used to insert tube 12 into the port 10 for use with microfluidic devices supplied with single-use tube 12 pre-attached. A suitable tool 54 is shown in FIGS. 25A-25G. The tool 58 comprises a collet plunger 60 and collet sleeve 62 for connecting the tube 12 to a port 10. The tube 12 is fitted to the collet plunger 60 through slit 64 which extends the length of the collet plunger 60. Collet plunger 60 is then inserted into the bore 66 of the collet sleeve 62 through alignment of flats 68 on the plunger 60 with a slot 70 in the sleeve 62. The plunger 60 is then rotated so that there is a concentric engagement of the sleeve 62 with the plunger 60. A section (˜2 mm) of tube 12 is left protruding from the end of the plunger 60 and a base chamfer 72 of the plunger 60 rests on the top of an internal chamfer 74 at the base of the sleeve 62. The tube 12 is aligned with the port 10 and the plunger 60 is then depressed. This action compresses the plunger 60 onto the tube 12 through interference of tapers 76 on the sleeve 62 and the plunger 60, to grip the tube 12 strongly as it is forced downwards into the port 10. The sleeve 62 is withdrawn to the clearance diameter of the plunger 60 at its middle section. This allows the collet plunger 60 to release the tube 12 and the tool 58 is removed from the tube 12 and port 10 via the aligned slit 64 and slot 70 on the collet plunger 60 and collet sleeve 62.

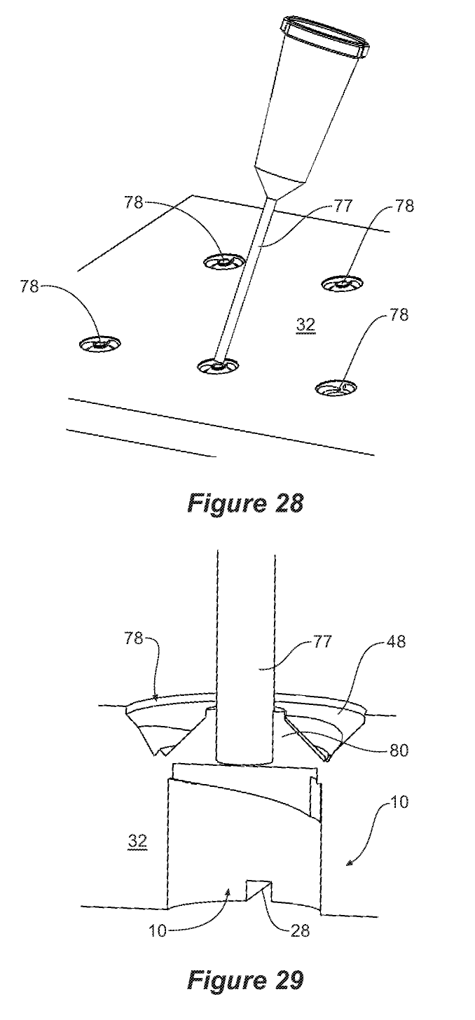

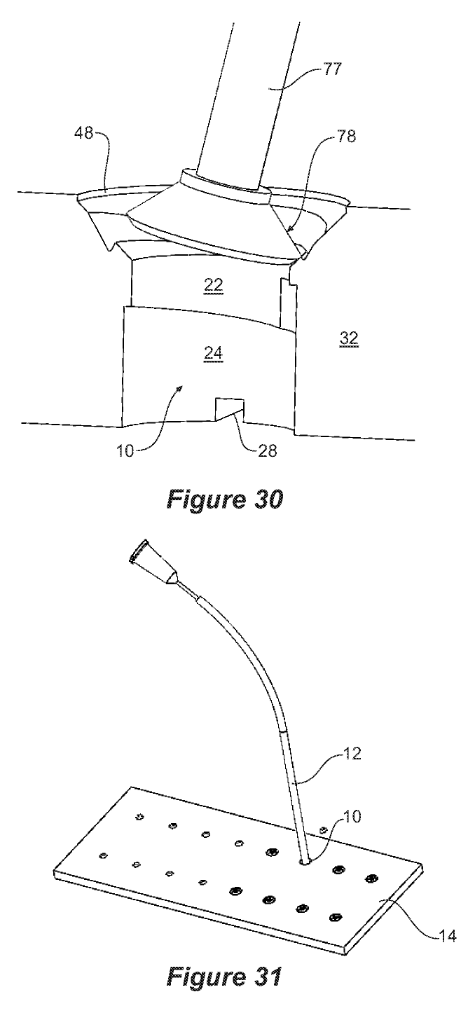

The present invention may also be used to form a sealed port which could be opened and assembled at the point-of-care (POC) in a hospital, surgery, veterinary or laboratory settings for microfluidic or other applications requiring capillary tube connections. This provides a cheap range of connection parts that may be used instead of a range of flanged or ferrule-fitted connection devices. Embodiments of a port 10 suitable for use in POC applications are shown in FIGS. 26A to 31. Commonly, connections to Tygon 0.06″ OD tube with a 0.02″ bore are commonly made with a 23 G needle 77. The port 10 of these embodiments comprises a threaded section 36 with a cap structure 78. The cap structure 78 incorporates a 45 degree chamfered section 48 with a tube end compression structure 54, and a cylindrical pocket 80 within the cap structure 78 which is designed to be a close fit to a 23 G needle 77. The port 10 is designed so that on application of a lateral force to the inserted needle 77, the weakest point 82 of the cap structure 78 breaks, leaving a port 10 with the desirable dimensions and structure for high-pressure fitment of the tube 12, which can be subsequently connected along the line by the same, or another 23 G needle.

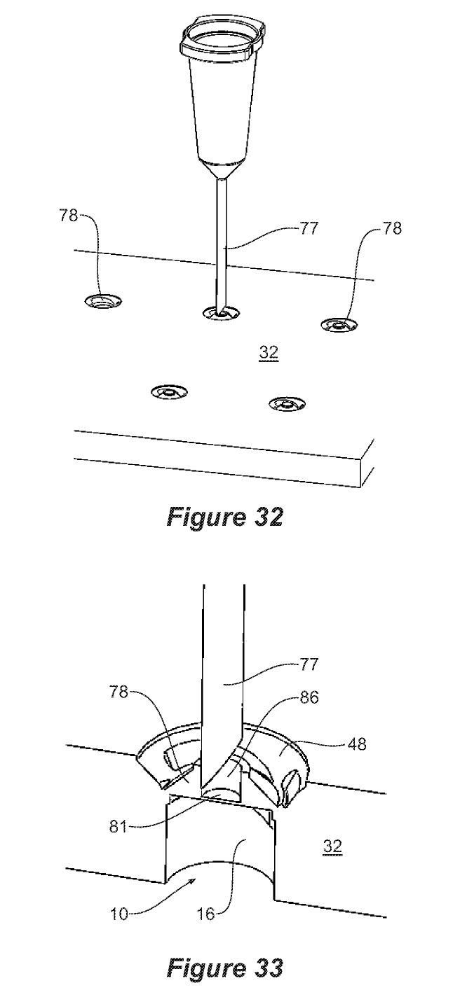

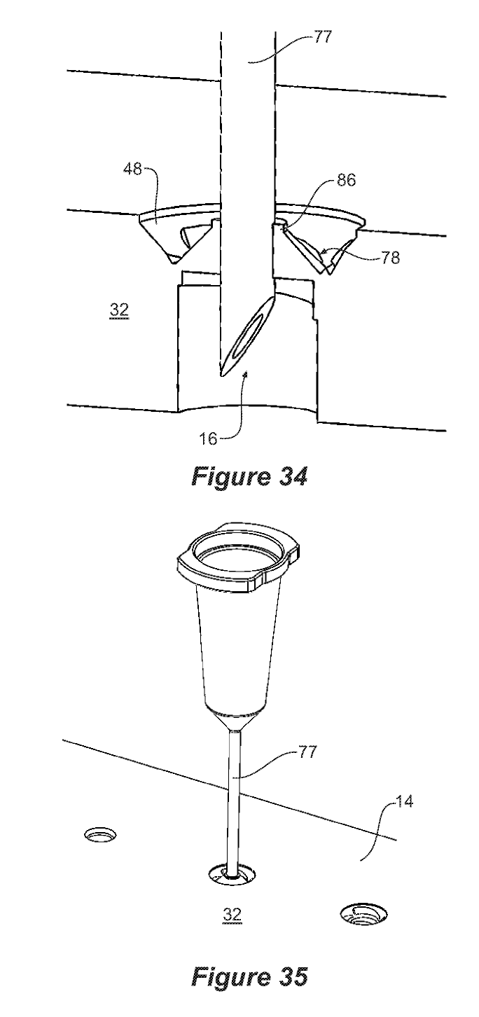

Alternatively, as shown in FIGS. 32 to 35 a sharp 23 G needle 77 can be used to puncture the base of the cylindrical pocket 80 of the cap structure 78 to administer a sample or reagent to the port by syringe. The size and shape of the cylindrical pocket 80 may be such that upon the insertion of a needle 77, a seal is substantially formed between the outer surface of the needle and the inner surface of the cylindrical pocket 80 so that it will withstand a pressure difference. The cylindrical pocket may also comprise a membrane 81 that can be pierced by the needle 77 upon insertion into the cylindrical pocket 80. These features of the cylindrical pocket 80 mean that a sample is largely protected from contamination in the enclosed structure of the port 10.

In other embodiments shown in FIGS. 36 to 44, the port 10 is incorporated into a standalone interconnect for tube connections to other fluid handling devices 14, such as Leur lock type pressure fittings (FIGS. 36 to 41) and ferrules (FIGS. 42 and 43). Importantly, such structures are very cheap to produce since complex, cored tooling is not required for the injection moulding process.

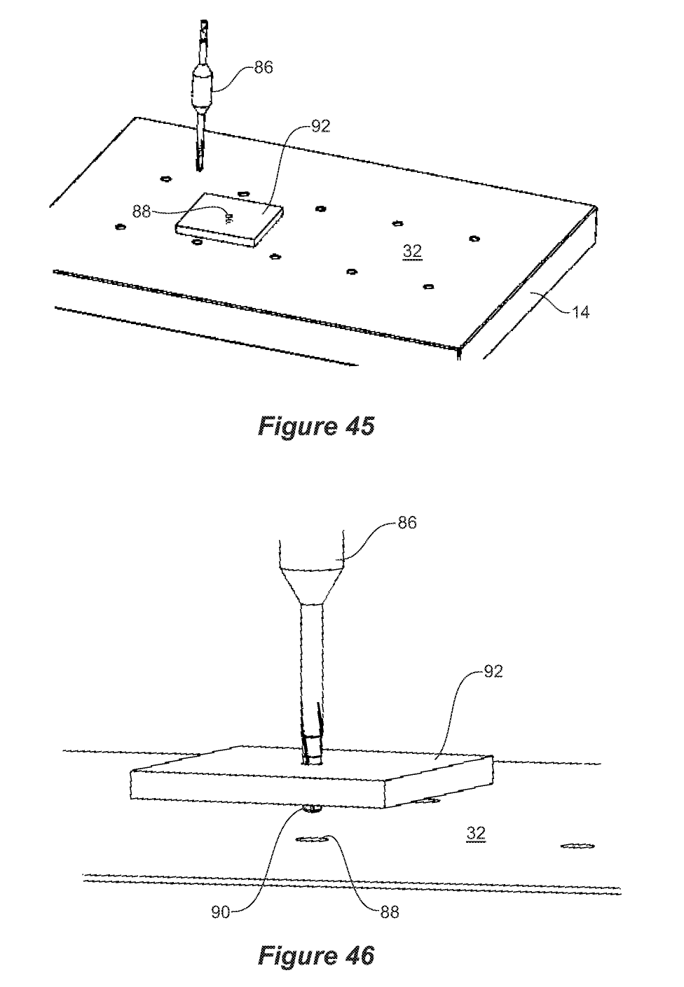

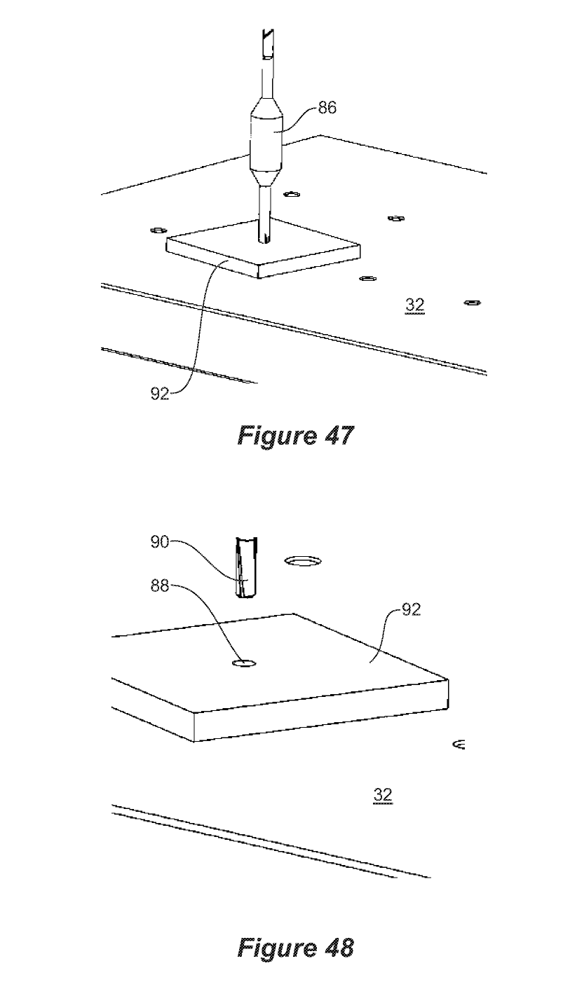

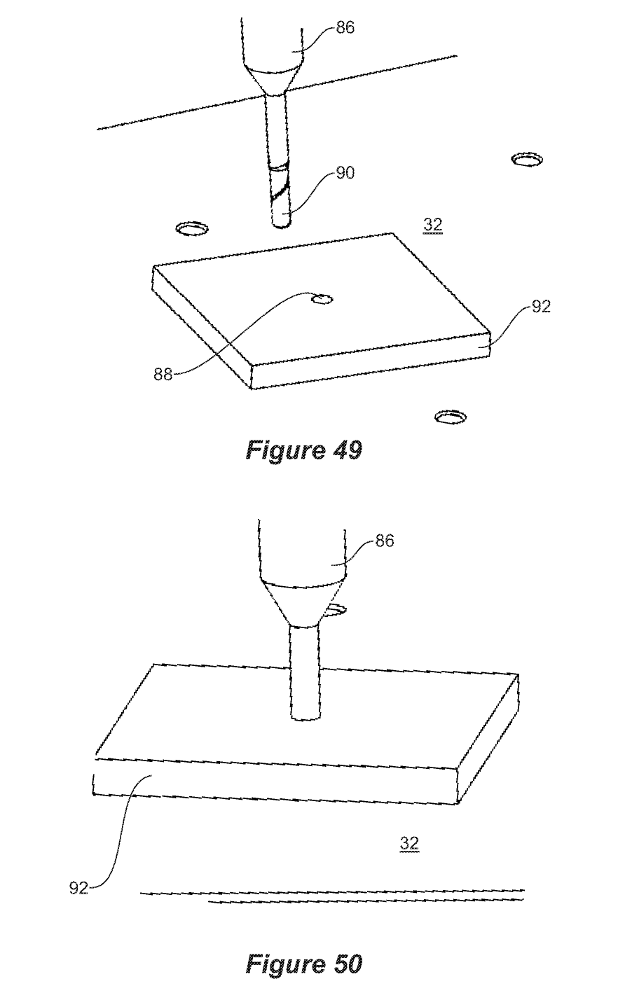

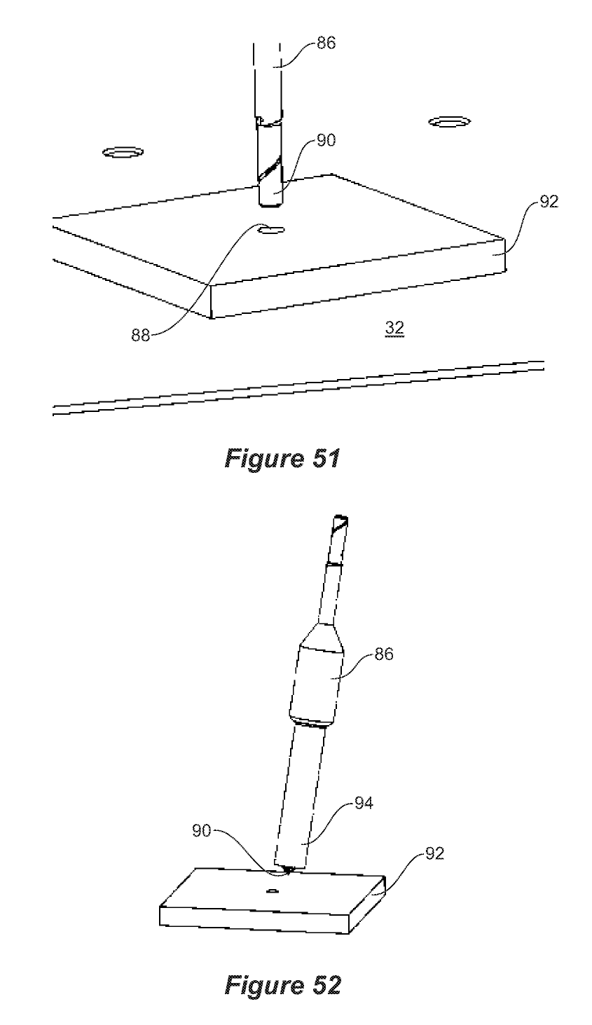

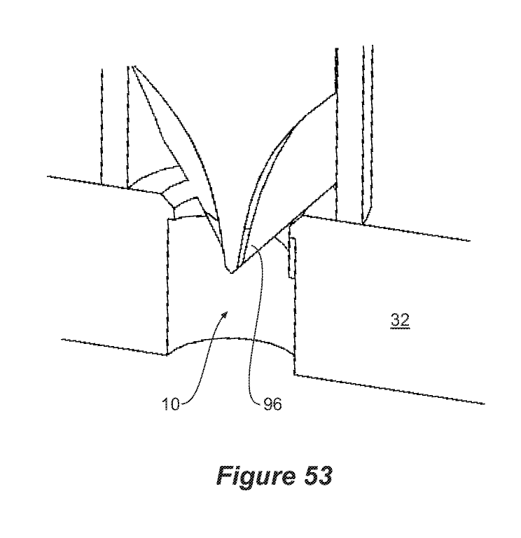

As discussed previously, the ports 10 may be incorporated into devices 14 during injection moulding. Alternatively, as shown in FIGS. 45 to 53 the ports 10 may be introduced into a substrate 30 by using a hand tool or reamer 86. To do this, a small pilot hole 88 is drilled in the substrate 30 at the desired location. The smallest diameter mandrel 90 of the reamer 86 communicates with the pilot hole 88, centring the tool. The stepped reamer then cuts both the smaller diameter bore section 22 and the larger diameter bore section 24. In this instance, the depth is determined by the concurrent use of an associated port reaming plate 92. The other end of the port reaming tool 86 has a mandrel 94 to centre the tool and teeth 96 to cut the inclined draft angle on the shoulder 26. The teeth 96 are shaped so as to produce the desired port 10 geometry and stop after an appropriate half turn with finger force. On removal of the spiral-toothed mandrel 94, the single spiral tooth removes burrs generated during the tooth cutting step. A hand tool for the production of the chamfered section 48 is also shown in FIG. 53. A shoulder stop that interferes with the outer plane of the substrate determines the depth of the chamfer produced.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

1. A fluid connection port comprising:
a unitary bore that includes a narrow diameter bore section;
a larger diameter bore section; and
a shoulder separating the narrow diameter bore section and the larger diameter bore section;
wherein the port is adapted and configured to form a working fluid connection between a deformable, flexible tube and a microfluidic fluid handling device that comprises an internal fluid handling feature;
and wherein in use the larger diameter bore section is situated adjacent the internal fluid handling feature of the microfluidic fluid handling device and the diameter of the bore at the narrow diameter bore section is less than the outside diameter of the deformable, flexible tube to which the bore is connected during use to thereby form a fluid tight compression seal directly between the full circumference of an outer surface of the deformable, flexible tube and an inner surface of the narrow diameter bore section and whereby the deformable, flexible tube expands radially as it extends into the larger diameter bore section so that the deformable, flexible tube substantially conforms to an inner surface of the bore at the shoulder so that the shoulder retains the deformable, flexible tube in the bore

2. The fluid connection port according to claim 1, wherein the fluid handling device is a microfluidic device.

3. The fluid connection port according to claim 1, wherein the diameter of the bore at the larger diameter bore section is also less than the outside diameter of the deformable, flexible tube.

4. The fluid connection port according to claim 1, wherein an internal wall of the bore further comprises a threaded section.

5. The fluid connection port according to claim 4, wherein the threaded section comprises a single turn thread.

6. The fluid connection port according to claim 4, wherein the threaded section comprises a single start thread or a multiple start thread.

7. The fluid connection port according to claim 1, further comprising a chamfered section at the top of bore at the exterior surface of the fluid handling device.

8. The fluid connection port according to claim 7, further comprising a tube end compression structure on or around the chamfered section, wherein, in use, the tube end compression structure engages with the tube and compresses it radially as it is inserted into the port.

9. The fluid connection port according to claim 1, further comprising a lead-in bore between the exterior surface of the fluid handling device and the entry to the bore of the port, wherein the lead-in bore is configured to facilitate insertion of the tube and/or to translate laterally applied load on the tube into axial load and reduce the chance of inadvertent removal of the tube or induction of leakage.

10. The fluid connection port according to claim 1, further comprising a cap structure comprising a chamfered section, a tube end compression structure, and a cylindrical pocket within the cap structure.

11. A microfluidic fluid handling device comprising:
a substrate;
at least one fluid handling channel or feature formed in the substrate; and
a fluid connection port for forming a working fluid connection between a deformable, flexible tube and the microfluidic fluid handling device; the fluid connection port comprising a unitary bore extending from an exterior surface of the fluid handling device to the fluid handling channel or feature, the bore comprising a narrow diameter bore section adjacent the exterior surface of the fluid handling device, a larger diameter bore section adjacent the fluid handling feature, and a shoulder separating the narrow diameter bore section and the larger diameter bore section;
wherein the diameter of the bore at the narrow diameter bore section is less than the outside diameter of the deformable, flexible tube, wherein the port is adapted and configured to form a working fluid connection between a deformable, flexible tube and the microfluidic fluid handling device; and
wherein in use a fluid tight compression seal is formed directly between the full circumference of an outer surface of the deformable, flexible tube and an inner surface of the narrow diameter bore section and the deformable, flexible tube expands radially as it extends into the larger diameter bore section so that the deformable, flexible tube substantially conforms to an inner surface of the bore at the shoulder so that the shoulder retains the deformable, flexible tube in the bore.

12. The fluid handling device according to claim 11, wherein the device is a microfluidic device and the fluid handling channel or feature is a microfluidic channel or feature.

13. The fluid handling device according to claim 11, wherein the diameter of the bore at the larger diameter bore section is also less than the diameter of the deformable, flexible tube.

14. The fluid handling device according to claim 11, wherein an internal wall of the bore further comprises a threaded section.

15. The fluid handling device according to claim 14, wherein the threaded section comprises a single turn thread.

16. The fluid handling device according to claim 14, wherein the threaded section comprises a single start thread or a multiple start thread.

17. The fluid handling device according to claim 11, further comprising a chamfered section at the top of bore at the exterior surface of the fluid handling device.

18. The fluid handling device according to claim 17, further comprising a tube end compression structure on or around the chamfered section, wherein, in use, the tube end compression structure engages with the tube and compress it radially as it is inserted into the port.

19. The handling device according to claim 11, further comprising a lead-in bore between the exterior surface of the fluid handling device and the entry to the bore of the port, wherein the lead-in bore is configured to facilitate insertion of the tube and/or to translate laterally applied load on the tube into axial load and reduce the chance of inadvertent removal of the tube or induction of leakage.

20. The fluid handling device according to claim 11, further comprising a cap structure comprising a chamfered section, a tube end compression structure, and a cylindrical pocket within the cap structure.
